(19) United States
(12) Patent Application Publication
(10) Pub. No.: US 2015/0236366 A1
(43) Pub. Date: Aug. 20, 2015

(54) FLEXIBLE FUEL CELL AND METHOD OF FABRICATING THEREOF

(71) Applicants: SNU R&DB Foundation, Seoul (KR); Global Frontier Center for Multiscale Energy Systems, Seoul (KR)

(72) Inventors: Ik Whang CHANG, Daegu (KR); Jin Hwan LEE, Daejeon (KR); Tae Hyun PARK, Seoul (KR); Suk Won CHA, Seoul (KR); Seung Hwan KO, Seoul (KR)

(73) Assignees: SNU R&DB Foundation, Seoul (KR); Global Frontier Center for Multiscale Energy Systems, Seoul (KR)

(21) Appl. No.: 14/576,929

(22) Filed: Dec. 19, 2014

(30) Foreign Application Priority Data
Feb. 14, 2014 (KR) 10-2014-0017387

(51) Int. Cl. H01M 8/10; H01M 8/02; H01M 8/04

(52) U.S. Cl. CPC H01M 8/1004; H01M 8/04201; H01M 8/02; H01M 8/1018; H01M 8/0204; H01M 8/0206; H01M 8/0221; H01M 2008/1095; H01M 2300/0082; H01M 2250/30

(57) ABSTRACT

Provided is a flexible fuel cell. The flexible fuel cell includes: an anode including an anode end plate structure made of a polymer material and having a hydrogen flow channel formed therein, and a current collector having a conductive layer deposited on the structure; a cathode including a cathode end plate structure made of a polymer material and having an air flow channel formed therein, and a current collector deposited on the structure; and a membrane electrode assembly (MEA) including a polymer electrolyte membrane having a catalyst layer attached to the surface thereof, and provided with a gas diffusion layer (GDL) on at least one surface thereof, wherein the polymer material includes an adhesive polymer and a curing agent mixed at a ratio of 4:1-20:1, and the membrane electrode assembly is interposed between the anode and the cathode and subjected to compression, wherein the compression is carried out while the ends of the membrane electrode assembly, anode and cathode are bent and tensile stress is applied thereto or compressive stress is applied thereto.

### CROSS-REFERENCE TO RELATED APPLICATIONS

This application claims priority under 35 U.S.C. §119 to Korean Patent Application No. 10-2014-0017387 filed on Feb. 14, 2014 in the Korean Intellectual Property Office, the disclosure of which is incorporated herein by reference in its entirety.

### TECHNICAL FIELD

The following disclosure relates to a flexible fuel cell, and more particularly to a flexible fuel cell having excellent clamping force by reducing the softness of a polymer material forming an end plate, and a method for producing the same.

### BACKGROUND

It is known that polymer electrolyte fuel cells (PEFCs) have the highest output power density and battery durability. Moreover, PEFCs are capable of operating at low temperature, and thus are suitable for application to portable devices.

Recently, flexible devices are increasingly in demand for various applications including energy devices. Soft matrices such as polymers and metal foil have gradually received many attentions in the fields of flexible displays and electronic sensors. The meaning of flexibility may be classified based on the following three categories: how much the system in question is bendable, how much the system in question is permanently shaped, and how much the system is elastically stretchable. Of them, most studies about flexible electronic devices are generally based on how much the system in question is bendable, and how much the system is elastically stretchable.

Among the flexible matrices such as glass, plastic films and metal foil, polydimethylsiloxane (PDMS)-based flexible electronic devices have been studied widely by many workers. Many studies have been reported about bioapplicable electronic devices and photoelectronic devices (Non-patent Documents 1 and 2). In addition, for H₂—O₂ flexible fuel cells having an active area of 10-100 mm², it is reported that such fuel cells provide a peak output power density of 57 mW/cm² (Non-patent Document 3). However, the above studies merely suggest stacked structures having a simple shape including a single cell using organic substances and gold-plated Cu mesh.

### REFERENCES

### Non-Patent Document

Non-Patent Document 1: D.-H. Kim, J. A. Rodgers, Adv. Mater. 20 (2008) 4887; G. Shin.

Non-Patent Document 2: I. Jung, V. Malyarchuk, J. Song, S. Wang, H. C. Ko, Y. Huang, J. S. Ha, J. A. Rogers, Small 6 (2010) 851.

Non-Patent Document 3: J. Wheldon, W. J. Lee, D. H. Lee, A. B. Broste, M. Bollinger, W. H. Smyrl, Electrochem. SolidSt. 12 (2009) B86.

### SUMMARY

An embodiment of the present invention is directed to providing a flexible fuel cell having excellent clamping force by using a material having high flexibility for an anode end plate and cathode end plate and by adjusting the proportion of a curing agent.

Another embodiment of the present invention is directed to providing a method for producing the flexible fuel cell.

In one aspect, there is provided a flexible fuel cell, including:

(a) an anode including an anode end plate structure made of a polymer material and having a hydrogen flow channel formed therein, and a current collector having a conductive layer deposited on the structure;

(b) a cathode including a cathode end plate structure made of a polymer material and having an air flow channel formed therein, and a current collector deposited on the structure; and

(c) a membrane electrode assembly (MEA) including a polymer electrolyte membrane having a catalyst layer attached to the surface thereof, and provided with a gas diffusion layer (GDL) on at least one surface thereof,

wherein the polymer material includes an adhesive polymer and a curing agent mixed at a ratio of 2:1-20:1, and

the membrane electrode assembly is interposed between the anode and the cathode and subjected to compression, wherein the compression is carried out while the ends of the membrane electrode assembly, anode and cathode are bent and tensile stress is applied thereto or compressive stress is applied thereto.

According to an embodiment, the adhesive polymer may be selected from the group consisting of polydimethylsiloxane, poly(methyl methacrylate), polyvinyl chloride), polycarbonate, polystyrene, polyurethane, polystyrene, polybutadiene and a mixture thereof.

According to another embodiment, the current collector having a conductive polymer may be obtained by depositing a first conductive layer and a second conductive layer successively on the structure through a sputtering process, wherein each of the first conductive layer and the second conductive layer independently includes a metal selected from nickel (Ni), gold (Au), silver (Ag), platinum (Pt), chrome (Cr), iron (Fe), manganese (Mn), copper (Cu), aluminum (Al), titanium (Ti), lanthanum (La), magnesium (Mg), molybdenum (Mo), zinc (Zn), lead (Pb), tin (Sn) and tungsten (W), or a metal oxide thereof; a conductive carbon structure formed of carbon nanotubes or graphene; or a conductive polymer selected from poly(3,4-ethylenedioxythiophene) (PEDOT), poly(3,4-ethylenedioxythiophene)-poly(styrenesulfonate) (PEDOT:PSS) and poly(3,4-ethylenedioxythiophene)-tetramethacrylate (PEDOT:TMA).

According to still another embodiment, the first conductive layer may have a thickness of 10-5,000 nm, and the second conductive layer may have a thickness of 10-5,000 nm.

According to still another embodiment, the current collector having a conductive layer may be formed of metal mesh having a mesh size of 10-250, and the metal may be at least one metal selected from nickel (Ni), gold (Au), silver (Ag), platinum (Pt), chrome (Cr), iron (Fe), manganese (Mn), copper (Cu), aluminum (Al), titanium (Ti), lanthanum (La), magnesium (Mg), molybdenum (Mo), zinc (Zn), lead (Pb), tin (Sn) and tungsten (W), or a metal oxide thereof.

According to yet another embodiment, the current collector having a conductive layer may be formed of metal foil, and the metal may be at least one metal selected from nickel (Ni), gold (Au), silver (Ag), platinum (Pt), chrome (Cr), iron (Fe), manganese (Mn), copper (Cu), aluminum (Al), titanium (Ti), lanthanum (La), magnesium (Mg), molybdenum (Mo), zinc (Zn), lead (Pb), tin (Sn) and tungsten (W), or a metal oxide thereof. In another aspect, there is provided a method for producing a flexible fuel cell, including the steps of:

(a) providing a stainless steel substrate as a mold, coating the substrate with a polymer material, and removing the substrate by using a lift-off process to form each of an anode end plate structure and a cathode end plate structure;

(b) depositing a first conductive layer and a second conductive layer successively on each of the anode end plate structure and the cathode end plate structure through a sputtering process, thermal evaporation process, chemical vapor deposition process or electroless plating process; and

(c) interposing a membrane electrode assembly (MEA) between the anode end plate structure and the cathode end plate structure, and carrying out compression,

wherein the compression is carried out while the ends of the membrane electrode assembly, anode and cathode are bent and tensile stress is applied thereto or compressive stress is applied thereto.

According to an embodiment, step (a) may be carried out by forming each of the anode end plate structure and the cathode end plate structure through an injection molding or extrusion molding process instead of the above-mentioned process.

According to another embodiment, in step (a), each of the anode end plate structure and the cathode end plate structure may be formed in such a manner that a hydrogen flow channel is formed in the anode end plate structure, and an air flow channel is formed in the cathode end plate structure, wherein the air flow channel is in the form of a hole penetrating in a rectangular shape and corresponds to the hydrogen flow channel.

According to still another embodiment, the method may further include, prior to step (b), a step of treating each of the anode end plate structure and the cathode end plate structure with sonication in ethanol solution, and treating the surface of each structure with sand paper.

According to yet another embodiment, the membrane electrode assembly may include a polymer electrolyte membrane having a catalyst layer attached tightly to the surface thereof, and a gas diffusion layer (GDL) may be provided on at least one surface of the membrane electrode assembly.

The fuel cell according to the present invention includes an end plate obtained by using a polymer material having high flexibility, shows increased clamping force of an end plate by adjusting the proportion of a curing agent, and is obtained by forming a current collector directly on an end plate material to provide an anode and a cathode, which in turn are compressed together with a membrane electrode assembly. Therefore, the fuel cell according to the present invention shows excellent flexibility and clamping force, and thus is applicable to various industrial fields. In addition, even when tensile stress or compressive stress is applied to the fuel cell, there is no decrease in electrical contact between one layer and another layer of the fuel cell. As a result, the fuel cell according to the present invention shows higher stability, durability and efficiency as compared to the conventional flexible fuel cells.

### BRIEF DESCRIPTION OF THE DRAWINGS

FIG. 1 is a flow chart illustrating the method for producing a flexible fuel cell according to an embodiment.

FIG. 2 shows graphs illustrating the I-V characteristics of the flexible fuel cell according to an embodiment (graph (a)) and those of the flexible fuel cell according to Comparative Example (graph (b)).

FIG. 3a and FIG. 3b shows images of the flexible fuel cell according to an embodiment under non-bent condition (FIG. 3a) and under bent condition (FIG. 3b), respectively.

FIG. 4a and FIG. 4b are scanning electron microscopy (SEM) images showing the section and surface of a polydimethylsiloxane (PDMS)-based structure and a current collector including a Ni layer and Au layer formed thereon according to an embodiment, and FIG. 4c shows an image of the fuel cell according to an embodiment.

FIGS. 5a, 5b and 5c shows schematic views illustrating a fuel cell formed by binding an anode, cathode and membrane electrode assembly under non-stress condition (FIG. 5a), under compressive stress condition (FIG. 5b), and under tensile condition (FIG. 5c), respectively.

FIG. 6a is a graph illustrating the I-V characteristics of the flexible fuel cell provided with a gas diffusion layer (GDL) or not according to an embodiment.

FIG. 6b is a graph illustrating the ohmic resistance values of the flexible fuel cell provided with a gas diffusion layer (GDL) or not according to an embodiment.

### DETAILED DESCRIPTION OF EMBODIMENTS

Hereinafter, the present invention will be described in detail with reference to the accompanying drawings.

The polymer-based fuel cell according to the present invention uses a polymer material, particularly polydimethylsiloxane (PDMS) as an end plate material, and metallic films deposited on patterned PDMS through sputtering as a current collector, and thus is capable of bending without any significant degradation of quality even under bent condition.

A flexible fuel cell includes the following three main parts: a membrane electrode assembly (MEA), an anode and a cathode each provided with a current collector, and an anode end plate and a cathode end plate.

In one aspect, there is provided a flexible fuel cell, including: (a) an anode including an anode end plate structure made of a polymer material and having a hydrogen flow channel formed therein, and a current collector having a conductive layer deposited on the structure; (b) a cathode including a cathode end plate structure made of a polymer material and having an air flow channel formed therein, and a current collector deposited on the structure; and (c) a membrane electrode assembly (MEA) including a polymer electrolyte membrane having a catalyst layer attached to the surface thereof, and provided with a gas diffusion layer (GDL) on at least one surface thereof.

In general, as a material for forming an end plate for fuel cells, an adhesive polymer such as PDMS and a curing agent are mixed and used at a ratio of 10:1. However, in order to apply to flexible fuel cells, the polymer material may include an adhesive polymer and a curing agent at a ratio of from 2:1 to 20:1 according to an embodiment. When the adhesive polymer is used in an amount lower than the above ratio, the polymer material shows decreased flexibility, and thus the bending of a fuel cell may be inhibited. Preferably, the ratio may be 10:1.

The membrane electrode assembly is interposed between the anode and the cathode and subjected to compression, wherein the compression is carried out while the ends of the membrane electrode assembly, anode and cathode are bent and tensile stress is applied thereto or compressive stress is applied thereto.

The adhesive polymer may be a thermosetting polymer or thermoplastic polymer. Particularly, the adhesive polymer may be selected from the group consisting of polydimethylsiloxane, poly(methyl methacrylate), polyvinyl chloride), polycarbonate, polystyrene, polyurethane, polystyrene, polybutadene and a mixture thereof. Preferably, the adhesive polymer may be polydimethylsiloxane.

Polydimethylsiloxane includes a silicone elastomer having a low Young's modulus and has high flexibility (360-870 kPa), which is significantly higher as compared to the conventional end plate materials, such as polycarbonate (2.4 GPa), graphite (10 GPa) and stainless steel (190 GPa). Therefore, polydimethylsiloxane allows realization of flexible fuel cell in pursuit of the present invention.

The current collector includes a conductive layer deposited directly on an end plate structure as a thin film in order to improve the buffering function and easy fuel gases transport between an end plate and an anode or cathode. Preferably, a first conductive layer and a second conductive layer are deposited successively through a sputtering process. Each of the first conductive layer and the second conductive layer independently includes a metal selected from nickel (Ni), gold (Au), silver (Ag), platinum (Pt), chrome (Cr), iron (Fe), manganese (Mn), copper (Cu), aluminum (al), titanium (Ti), lanthanum (La), magnesium (Mg), molybdenum (Mo), zinc (Zn), lead (Pb), tin (Sn) and tungsten (W), or a metal oxide thereof; a conductive carbon structure formed of carbon nanotubes or graphene; or a conductive polymer selected from poly(3,4-ethylenedioxythiophene) (PEDOT), poly(3,4-ethylenedioxythiophene)-poly(styrenesulfonate) (PEDOT:PSS) and poly(3,4-ethylenedioxythiophene)-tetramethacrylate (PEDOT:TMA). Preferably, the first conductive layer may be Ni and the second conductive layer may be Au.

In addition, the conductive layer may be in the form of metal foil or metal mesh, not a film formed through sputtering. In the case of metal mesh, it preferably has a mesh size of 10-250 μm, because a mesh size exceeding 250 μm (which is a limit in diffusion of oxygen passing through metal mesh to reach a cathode) makes permeation of oxygen difficult and leads to degradation of the quality of a fuel cell.

The membrane electrode assembly is interposed between the anode and the cathode and subjected to compression. Herein, the compression is carried out while the ends of the membrane electrode assembly, anode and cathode are bent and tensile stress is applied thereto or compressive stress is applied thereto.

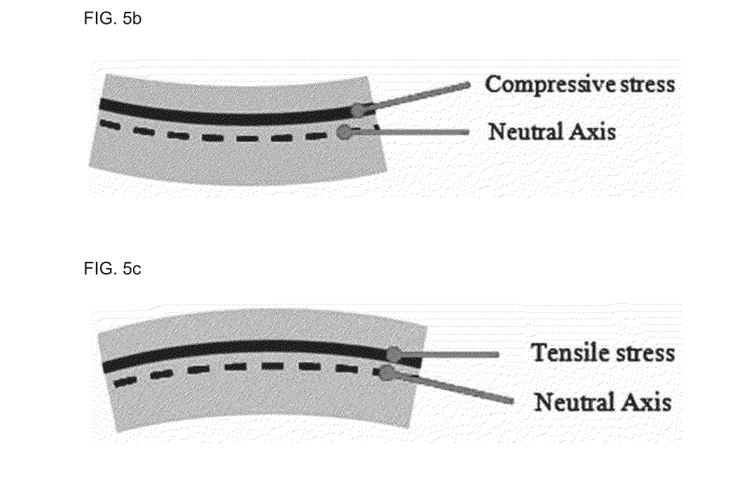

FIG. 5b and FIG. 5c illustrate the membrane electrode assembly under the application of compressive stress and tensile stress, respectively. In other words, when the membrane electrode assembly is formed by compressing it under bent condition, the resultant flexible fuel cell uniformly receives pressure applied from the central portion and ends thereof. Therefore, even at the ends spaced apart from the central portion, electrical contact can be improved. As a result, it is possible for the flexible fuel cell to realize excellent quality even under bent condition.

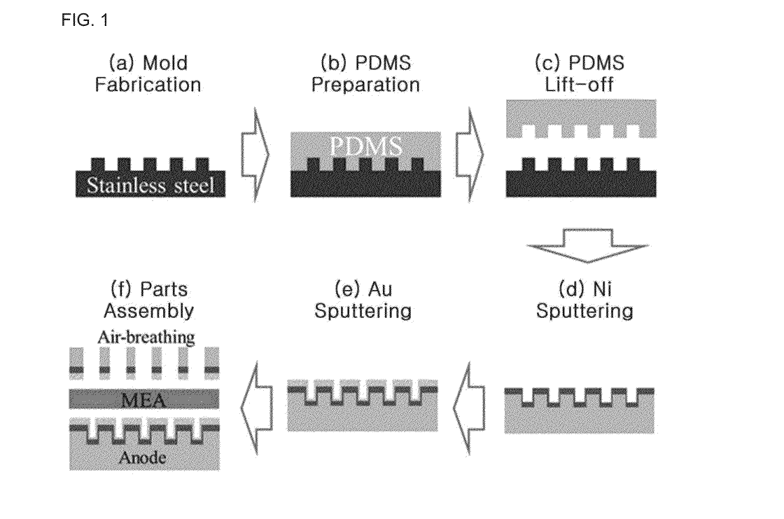

FIG. 1 is a flow chart illustrating the method for producing a flexible fuel cell according to an embodiment. The method for producing a flexible fuel cell according to the present invention includes the steps of:

(a) providing a stainless steel substrate as a mold, coating the substrate with a polymer material, and removing the substrate by using a lift-off process to form each of an anode end plate structure and a cathode end plate structure;

(b) depositing a first conductive layer and a second conductive layer successively on each of the anode end plate structure and the cathode end plate structure through a sputtering process, thermal evaporation process, chemical vapor deposition process or electroless plating process; and

(c) interposing a membrane electrode assembly (MEA) between the anode end plate structure and the cathode end plate structure, and carrying out compression.

### EXAMPLES

The examples and experiments will now be described. The following examples and experiments are for illustrative purposes only and not intended to limit the scope of this disclosure.

### Example: Production of Flexible Fuel Cell

(1) A stainless steel mold for producing an anode end plate structure is provided in such a manner that a hydrogen flow channel having a width, depth (or height) and length of 1 mm, 1 mm and 30 mm is formed in the anode end plate structure. In addition, a stainless steel mold for producing a cathode end plate structure is provided in such a manner that a rectangular air flow channel having a width, depth (or height) and length of 2.5 mm, 6 mm and 28 mm is formed in the cathode end plate structure.

The cathode is open to the air without any forced air injection/compression system (i.e., air-respirable type). The cathode has an increased open area, because it is known that oxygen reduction at a cathode causes the most severe loss in quality. However, the open area cannot be increased unrestrictedly due to a problem of structural stability, and clamping force transferred to the MEA should be considered. Thus, according to an embodiment, the open area is set to be less than 50% (particularly 38%).

(2) Polydimethylsiloxane and a curing agent are mixed at a ratio of 5:1, and then heated at 70° C. for 4 hours.

(3) Each stainless steel mold is coated with polydimethylsiloxane, and an anode end plate structure and cathode end plate structure each having a size of 4 cm×4 cm are obtained through a lift-off process.

(4) Each structure is treated with ultrasonication in ethanol solution for 5 minutes. Then, the surface of the PDMS structure is pre-treated with sand paper to improve the adhesion of a conductive layer, and a thin film conductive layer functioning as a current collector is deposited on PDMS through a DC sputtering process. When carrying out sputtering, the distance between a target and a substrate is 6 cm, and the deposition power of a sputter is 200 W under a pressure of Ar of 5 mtorr.

First, a nickel (Ni) layer having a thickness of 880 nm is deposited on PDMS for 5 minutes. Then, a gold (Au) layer having a thickness of 3.8 μm is deposited on the Ni layer for 20 minutes under the same condition as the Ni layer deposition.

(5) The resultant structure including the membrane electrode assembly having the current collector deposited thereon is compressed to provide a three-layer structure (Ni/Au coated anode end plate, cathode end plate and MEA).

As the membrane electrode assembly, two types of MEAs are used. One MEA is commercially available (CNL, Korea) and includes a polymer membrane (Nation 212, Dupont) on which Pt catalyst is loaded in an amount of 0.4 mg/cm². Gas diffusion layer (GDLs) at both sides are formed by using SGL 10BC (SGL, USA) having a thickness of 420 μm. Another MEA has no gas diffusion layer. It is an MEA coated merely with catalyst without any gas diffusion layer.

The two types MEAs (with or without GDL) are tested by using the same test parameters, and each MEA has an active area of 3 cm×3 cm.

### Comparative Example

The above-described Example is repeated, except that polydimethylsiloxane (PDMS) and a curing agent are mixed at a ratio of 10:1, and heated at 70° C. for 4 hours.

### Test Example

(1) Current-Voltage (I-V) determination and electrochemical impedance spectroscopy (EIS) are carried out by using Solartron 1287/12660 combination. I-V characteristics are obtained in a galvano-dynamic mode at 3 mA/sec. EIS determination is carried out with AC perturbation of 30 mV under a constant bias of 0.3V. Moistened H₂ is supplied to the anode at 20° C. with a rate of 50 sccm. The cathode is open to the ambient environment (air-respirable).

The test is carried out in the order of 1) supplying H₂, 2) measuring OCV (open-circuit voltage) for 10 minutes, 3) carrying out galvano-electrostatic measurement at 0.1, 0.3 and 0.5 A for 10 minutes under moistening of each film and catalyst layer, 4) I-V determination, and 5) EIS determination.

(2) For the section of the PDMS end plate, focused ion beams (Quanta 3D FEG; FEI, Inc., Netherland) are used to obtain scanning electron microscopic images.

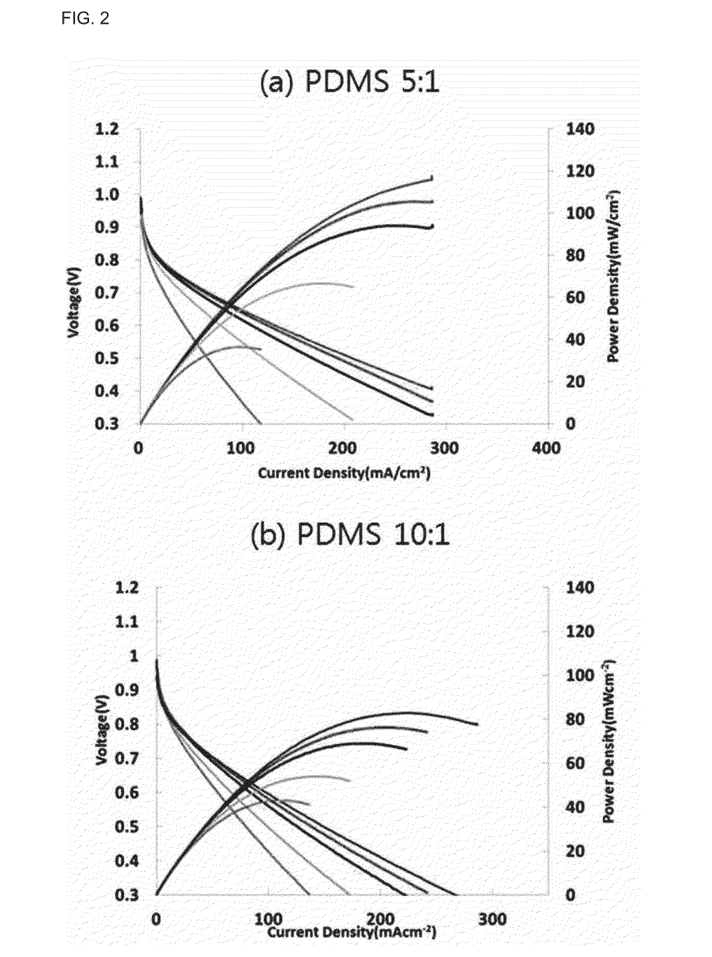

(3) FIG. 2a and FIG. 2b show the results of I-V determination of a flexible fuel cell using PDMS and a curing agent mixed at a ratio of 5:1 and 10:1, respectively. As shown in FIG. 2a and FIG. 2b, when PDMS and a curing agent are mixed at a ratio of 5:1, the fuel cell has a higher voltage under the same current density. This is because the end plate using an adhesive polymer and a curing agent at a ratio of 5:1 has increased hardness and shows improved clamping force.

(4) Although the end plate has an length of about 45 mm at the initial time of assemblage of a fuel cell, it has an length decreased to about 40 mm upon compression. The strain (ε) defined as a ratio of decrease in length based on the initial length measured along the central line is 11% in the case of a bent cell.

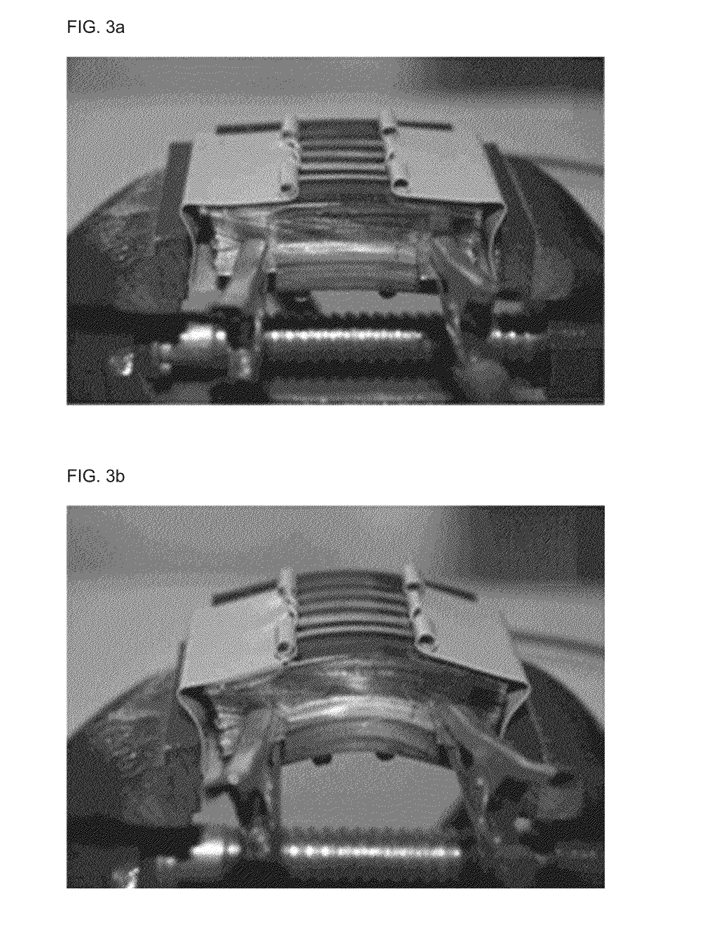

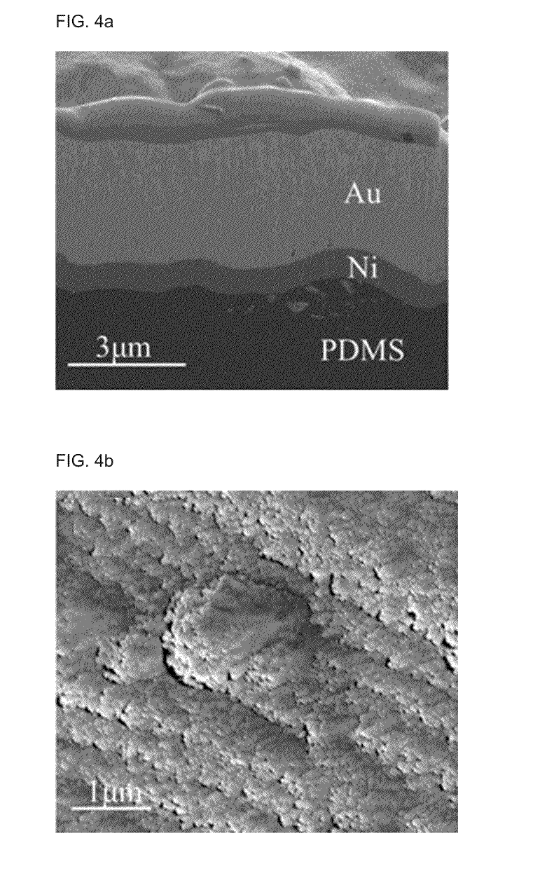

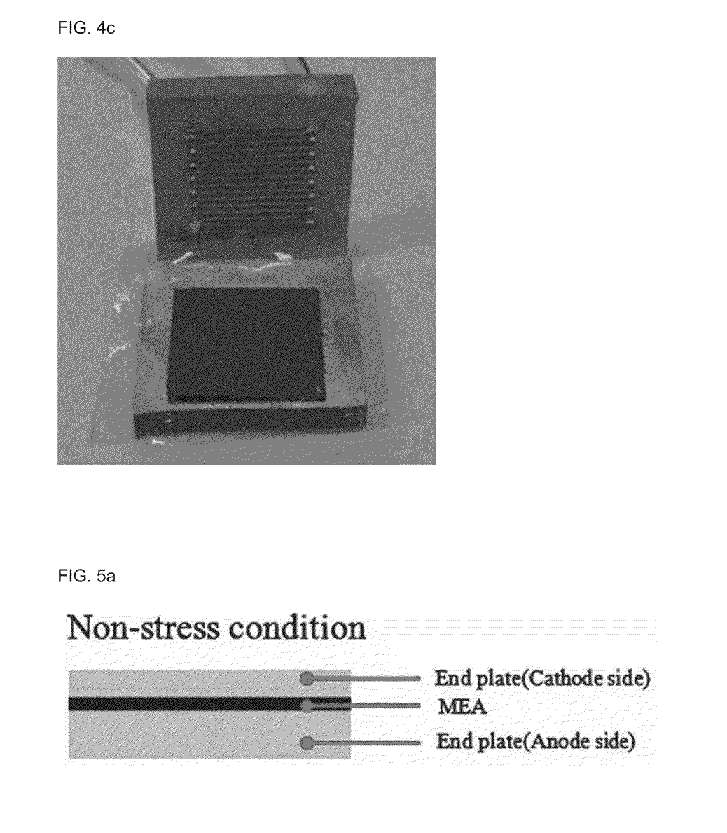

(5) Under non-bent condition (FIG. 3a) and under bent condition (FIG. 3b) caused by a table vise, tests show the results of I-V determination of a fuel cell right after the compression and assemblage and under bent condition. The power density is 29.1 and 20.5 mW/cm² in each case and a similar OCV (˜1.0V) is obtained. Thus, it can be seen that the fuel cell according to the present invention undergoes no degradation in electrical contact at each structural element even under bent condition. From the results of impedance, the fuel cell realizes similar activation at different potential values.

However, as can be seen from the above I-V and EIS results, a difference in power density results from a difference in ohmic loss. It is thought that high ohmic loss in a bent cell results from rigidity of GDL and separation ability of a Ni/Au film from the thin film layers.

In other words, under bent condition, non-uniform pressure is applied to the cell due to the rigidity of GDL, leading to poor electrical contact at the ends spaced apart from the central portion. In addition, separation ability of a Ni/Au film from the thin film layers occurring during bending adversely affects ohmic resistance.

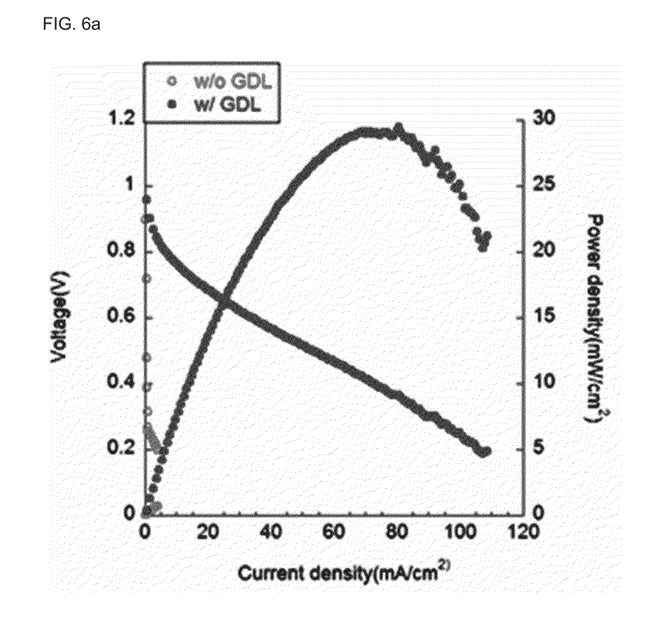

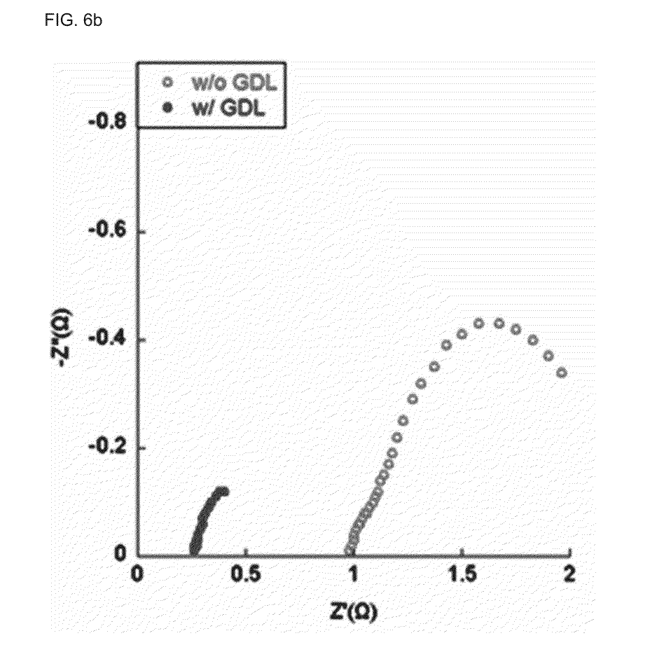

(6) FIG. 6a shows the I-V characteristics of fuel cells with or without GDL. As shown in FIG. 6a, fuel cells with GDL provide better I-V characteristics as compared to those without GDL. With regard to OCV, fuel cells with GDL provide an OCV of approximately 1 V but the other fuel cells provide an OCV less than 0.9V.

FIG. 6b suggests that fuel cells without GDL have an ohmic resistance about 4 times higher than the ohmic resistance of the other fuel cells (about 0.25 V/s. about 1.0 ohm at the highest frequency). In addition, the fuel cells without GDL show a more significant kinetic loss degree as compared to the other fuel cells. It is though that such a significant kinetic loss degree of the fuel cells without GDL results from a rough Au surface and low clamping force, and poor gas contact property caused thereby. GDL functions not only as a gap-filler but also as a buffer facilitating uniform distribution of mechanical pressure.

What is claimed is:

1. A flexible fuel cell comprising:
(a) an anode comprising an anode end plate structure made of a polymer material and having a hydrogen flow channel formed therein, and a current collector having a conductive layer deposited on the structure;
(b) a cathode comprising a cathode end plate structure made of a polymer material and having an air flow channel formed therein, and a current collector deposited on the structure; and
(c) a membrane electrode assembly (MEA) comprising a polymer electrolyte membrane having a catalyst layer attached to the surface thereof, and provided with a gas diffusion layer (GDL) on at least one surface thereof,
wherein the polymer material includes an adhesive polymer and a curing agent mixed at a ratio of from 2:1 to 20:1, and
the membrane electrode assembly is interposed between the anode and the cathode and subjected to compression, wherein the compression is carried out while the ends of the membrane electrode assembly, anode and cathode are bent and tensile stress is applied thereto or compressive stress is applied thereto.

2. The flexible fuel cell according to claim 1, wherein the adhesive polymer is selected from the group consisting of polydimethylsiloxane, poly(methyl methacrylate), poly(vinyl chloride), polycarbonate, polystyrene, polyurethane, polystyrene, polybutadene and a mixture thereof.

3. The flexible fuel cell according to claim 1, wherein the current collector having a conductive polymer is obtained by depositing a first conductive layer and a second conductive layer successively on the structure through a sputtering process,
wherein each of the first conductive layer and the second conductive layer independently comprises a metal selected from nickel (Ni), gold (Au), silver (Ag), platinum (Pt); chrome (Cr), iron (Fe), manganese (Mn), copper (Cu), aluminum (al), titanium (Ti), lanthanum (La), magnesium (Mg), molybdenum (Mo), zinc (Zn), lead (Pb), tin (Sn) and tungsten (W), or a metal oxide thereof; a conductive carbon structure formed of carbon nanotubes or graphene; or a conductive polymer selected from poly(3,4-ethylenedioxythiophene) (PEDOT), poly(3,4-ethylenedioxythiophene)-poly(styrenesulfonate) (PEDOT:PSS) and poly(3,4-ethylenedioxythiophene)-tetramethacrylate (PEDOT:TMA).

4. The flexible fuel cell according to claim 1, wherein the first conductive layer has a thickness of 10-5,000 nm, and the second conductive layer has a thickness of 10-6,000 nm.

5. The flexible fuel cell according to claim 1, wherein the current collector having a conductive layer is formed of metal mesh haying a mesh size of 10-250, and the metal is at least one metal selected from nickel (Ni), gold (Au), silver (Ag), platinum (Pt), chrome (Cr), iron (Fe), manganese (Mn), copper (Cu), aluminum (al), titanium (Ti), lanthanum (La), magnesium (Mg), molybdenum (Mo), zinc (Zn), lead (Pb), tin (Sn) and tungsten (W), or a metal oxide thereof.

6. The flexible fuel cell according to claim 1 wherein the current collector having a conductive layer is formed of metal foil and the metal is at least one metal selected from nickel (Ni), gold (Au), silver (Ag), platinum (Pt), chrome (Cr), iron (Fe), manganese (Mn), copper (Cu), aluminum (al), titanium (Ti), lanthanum (La), magnesium (Mg), molybdenum (Mo), zinc (Zn), lead (Pb), tin (Sn) and tungsten (W), or a metal oxide thereof

7. A method for producing a flexible fuel cell, comprising the steps of:
(a) providing a stainless steel substrate as a mold, coating the substrate with a polymer material, and removing the substrate by using a lift-off process to form each of an anode end plate structure and a cathode end plate structure;
(b) depositing a first conductive layer and a second conductive layer successively on each of the anode end plate structure and the cathode end plate structure through a sputtering process, thermal evaporation process, chemical vapor deposition process or electroless plating process; and
(c) interposing a membrane electrode assembly (MEA) between the anode end plate structure and the cathode end plate structure, and carrying out compression,
wherein the compression is earned out while the ends of the membrane electrode assembly, anode and cathode are bent and tensile stress is applied thereto or compressive stress is applied thereto.

8. The method for producing a flexible fuel cell according to claim 7, wherein step (a) is carried out by forming each of the anode end plate structure and the cathode end plate structure through an injection molding or extrusion molding process instead of the above process.

9. The method for producing a flexible fuel cell according to claim 7, wherein, in step (a), each of the anode end plate structure and the cathode end plate structure is formed in such a manner that a hydrogen flow channel is formed in the anode end plate structure, and an air flow channel is formed in the cathode end plate structure, wherein the air flow channel is in the form of a hole penetrating in a rectangular shape and corresponds to the hydrogen flow channel.

10. The method for producing a flexible fuel eel according to claim 7, which further comprises, prior to step (b), a step of treating each of the anode end plate structure and the cathode end plate structure with sonication in ethanol solution, and treating the surface of each structure with sand paper.

11. The method for producing a flexible fuel cell according to claim 7, wherein the adhesive polymer is selected from the group consisting of polydimethysiloxane, poly(methyl methacrylate), poly(vinyl chloride), polycarbonate, polystyrene, polyurethane, polystyrene, polybutadene and a mixture thereof.

12. The method for producing a flexible fuel cell according to claim 7, wherein each of the first conductive layer and the second conductive layer independently comprises a metal selected from nickel (Ni), gold (Au), silver (Ag), platinum (Pt), chrome (Cr), iron (Fe), manganese (Mn), copper (Cu), aluminum (al), titanium (Ti), lanthanum (La), magnesium (Mg), molybdenum (Mo), zinc (Zn), lead (Pb), tin (Sn) and tungsten (W), or a metal oxide thereof; a conductive carbon structure formed of carbon nanotubes or graphene; or a conductive polymer selected from poly(3,4-ethylenedioxythiophene) (PEDOT), poly(3,4-ethylenedioxythiophene)-poly(styrenesulfonate) (PEDOT:PSS) and poly(3,4-ethylenedioxythiophene)-tetramethacrylate (PEDOT:TMA).

13. The method for producing a flexible fuel cell according to claim 7, wherein the membrane electrode assembly comprises a polymer electrolyte membrane having a catalyst layer attached tightly to the surface thereof, and a gas diffusion layer (GDL) is provided on at least one surface of the membrane electrode assembly.
